(19) United States
(12) Patent Application Publication
(10) Pub. No.: US 2026/0059391 A1
(43) Pub. Date: Feb. 26, 2026

(54) ADAPTIVE SLA-DRIVEN QUALITY OF SERVICE TREATMENT SOLUTIONS SWITCHING FOR RADIO ACCESS NETWORK

(71) Applicant: AT&T Intellectual Property I, L.P., Atlanta, GA (US)

(72) Inventors: Ye Chen, Marietta, GA (US); Hongyan Lei, Plano, TX (US); Zhi Cui, Sugar Hill, GA (US)

(73) Assignee: AT&T Intellectual Property I, L.P., Atlanta, GA (US)

(21) Appl. No.: 18/810,669

(22) Filed: Aug. 21, 2024

(51) Int. Cl. H04W 28/24; H04W 28/02

(52) U.S. Cl. CPC H04W 28/24; H04W 28/0268

(57) ABSTRACT

Aspects of the subject disclosure may include, for example, selecting a quality of service (QoS) treatment for user equipment (UE) in a mobile communications network, applying the QoS treatment for the UE, determining compliance with a service level agreement (SLA) according to the QoS treatment, adjusting the QoS treatment to an updated QoS treatment based on the determining compliance with the SLA, and applying the updated QoS treatment to the UE. Other embodiments are disclosed.

### FIELD OF THE DISCLOSURE

The subject disclosure relates to a system and method for selecting an appropriate Quality of Service level for user equipment in a radio access network according to a service level agreement (SLA) for the user equipment.

### BACKGROUND

Quality of Service or QoS is an aspect of fourth generation (4G or LTE) and fifth generation (5G) mobile networks that works to ensure optimal performance for various applications or user equipment (UE) with different requirements. QoS involves prioritizing and managing network resources to deliver specific levels of service to different users or different types of traffic.

### BRIEF DESCRIPTION OF THE DRAWINGS

Reference will now be made to the accompanying drawings, which are not necessarily drawn to scale, and wherein:

FIG. 1 is a block diagram illustrating an exemplary, non-limiting embodiment of a communications network in accordance with various aspects described herein.

FIG. 2A is a block diagram illustrating an example, non-limiting embodiment of a system functioning within the communication network of FIG. 1 in accordance with various aspects described herein.

FIG. 2B depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for a system and method that adaptively selects a quality of service (QoS) treatment for a user equipment (UE) in a mobile network, based on comparing current performance of the UE relative to a service level agreement (SLA) for the UE. The SLA defines minimum performance commitments by the operator of the mobile network. If performance exceeds the SLA levels, the QoS may be adjusted to reduce priority for the UE in the network and free up network resources for other users. If the performance level for the UE falls below the SLA levels, the QoS may be adjusted to increases priority for the UE in the network and better conform to the SLA. Other embodiments are described in the subject disclosure.

One or more aspects of the subject disclosure include selecting a quality of service (QoS) treatment for user equipment (UE) in a mobile communications network, applying the QoS treatment for the UE, determining compliance with a service level agreement (SLA) according to the QoS treatment, adjusting the QoS treatment to an updated QoS treatment based on the determining compliance with the SLA, and applying the updated QoS treatment to the UE.

One or more aspects of the subject disclosure include applying an initial quality of service (QoS) treatment to user equipment (UE) in a mobile communication system, the initial QoS treatment corresponding to a relative priority of the UE for radio resources in the mobile communication system, operating the UE according to the initial QoS treatment, and retrieving service level agreement (SLA) information for the UE, the SLA information defining one or more minimum performance characteristics guaranteed to the UE by an operator of the mobile communications system. Aspects of the subject disclosure further include determining current performance information for the UE in the mobile communications system, comparing the current performance information for the UE with the one or more minimum performance characteristics guaranteed to the UE by the operator of the mobile communications system, adjusting the QoS treatment from the initial QoS treatment to an adjusted QoS treatment to adjust the relative priority of the UE for radio resources in the mobile communication system, wherein the adjusting is responsive to the comparing, and operating the UE on the mobile communication system according to the adjusted QoS treatment.

One or more aspects of the subject disclosure include selecting a first quality of service (QoS) treatment for user equipment (UE) in a radio access network, the first QoS treatment corresponding to a relative priority of the UE for radio resources in the radio access network, collecting performance information for the UE operating in the radio access network according to the first QoS treatment, receiving service level agreement (SLA) information for the UE, the SLA information defining a minimum performance level for the UE in the radio access network, comparing the performance information for the UE with the minimum performance level, adjusting UE QoS treatment from the first QoS treatment to a second QoS treatment to adjust the relative priority of the UE for radio resources in the radio access network, wherein the adjusting is responsive to the comparing, and updating the UE QoS treatment to the second QoS treatment.

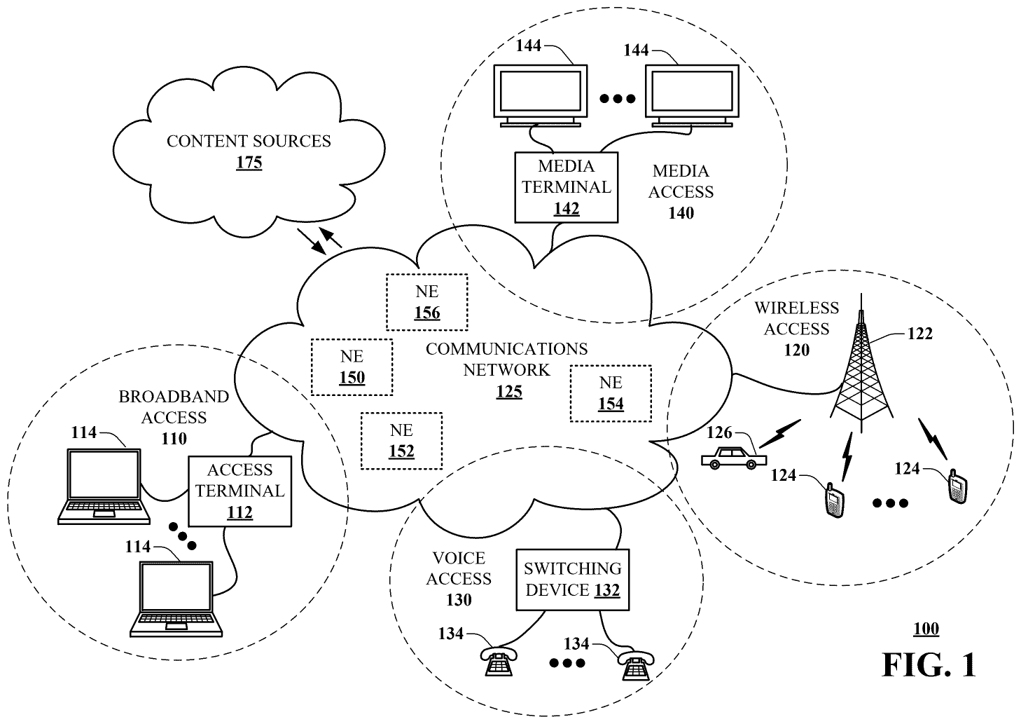

Referring now to FIG. 1, a block diagram is shown illustrating an example, non-limiting embodiment of a system 100 in accordance with various aspects described herein. For example, system 100 can facilitate in whole or in part automatically adjusting QoS for a UE in a mobile network to conform to a service level agreement for the UE. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communication network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or another switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

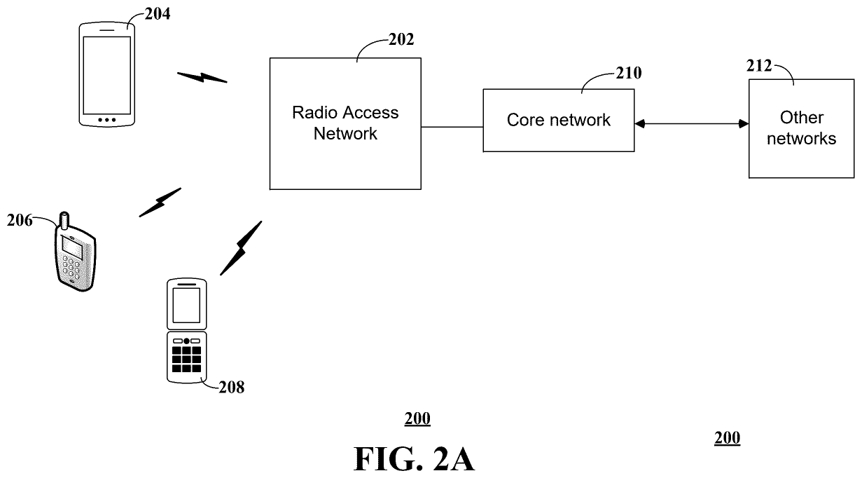

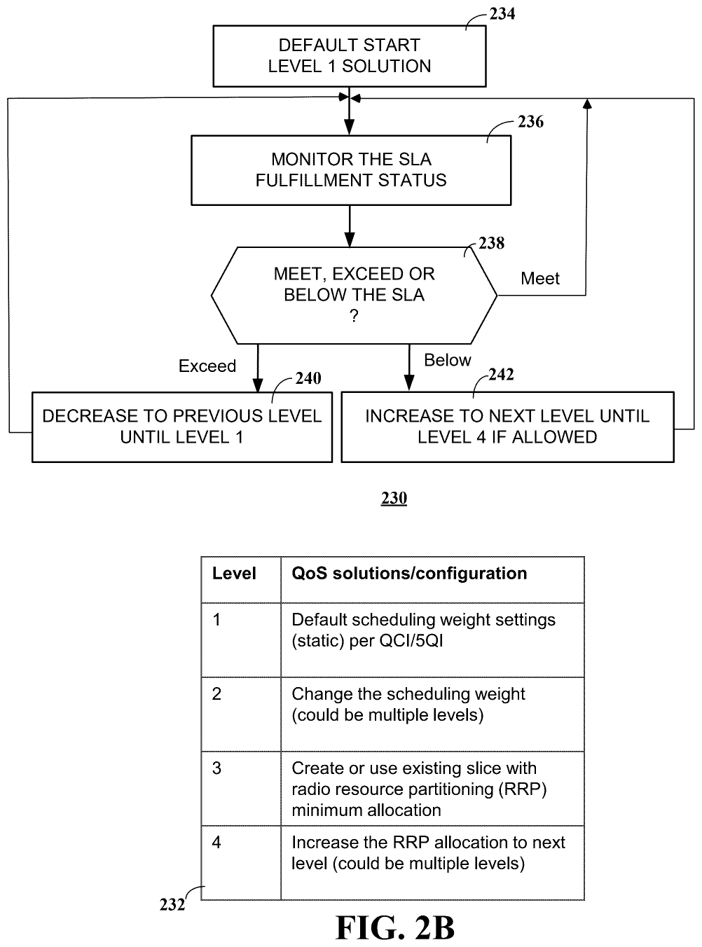

FIG. 2A is a block diagram illustrating an example, non-limiting embodiment of a mobile communication system 200 functioning within the communications network 125 of FIG. 1 in accordance with various aspects described herein. In exemplary embodiments, the mobile communication system 200 implements a communications network enabling radio communication between a radio access network (RAN) 202 and user equipment including UE 204, UE 206 and UE 208. The RAN 202 operates in conjunction with one or more core networks such as a core network 214. The core network 214 provides access to other networks 212 such as the public internet and private networks.

The RAN 202 may operate according to an air interface standard such as 4G cellular (LTE), 5G cellular including new radio (NR) and standalone (SA), combinations of these, and future developed radio technologies. The RAN 202 may include any number of base stations or fixed infrastructure, which may be referred to as eNodeB (eNB), gNodeB (gNB) or otherwise. The RAN 202 communicates by radio frequency between the base stations and user equipment such as UE 204, UE 206 and UE 208. The UE may be fixed or mobile radio devices. In some implementations, the UE may include internet of things (IoT) devices with limited functionality or communication ability.

The core network 210 implements a number of functions of importance to the mobile communications system 200. These include, for example, access and mobility management function (AUMF), authentication and server function (AUSF), session management function (SMF), unified data management (UDF) and a network slice selection function (NSSF) which controls network slicing.

Using virtualization, network slicing creates multiple logical networks on top of a shared, common physical infrastructure. Network slices may be implemented in the core network 210 or another network 212 in data communication with the core network 210. In examples, multiple network slices can be instantiated, and each network slice can be configured to meet the requirements of various applications, use cases, or customers. With network slicing, services are isolated based on their requirements, enhancing reliability and security. Each service can have its own network slice, allowing for better management of physical network resources.

As noted, the mobile communication system 200 operates in accordance with published standards such as those published by the 3^{rd} Generation Partnership Project (3GPP). 3GPP is a trademark of the European Telecommunication Standards Institute.

The published standard controls and defines many aspects of communication for a UE and a base station. One such aspect is quality of service or QoS.

QoS is an aspect of LTE, 5G, and other mobile networks that seeks to ensure optimal performance for various applications with different requirements. QoS involves prioritizing and managing network resources to deliver specific levels of service to different users or types of traffic. One aspect of QoS is prioritization. Different types of traffic, such as voice, video, and data, have different sensitivities to network limitations such as delays, jitter, and packet loss. QoS assigns priorities to these traffic types to ensure critical services like voice calls are not affected by heavy data usage. A second aspect of QoS is allocation of resources. QoS determines how network resources, including bandwidth, power, etc., are allocated to different users or services based on their QoS requirements. A third aspect of QoS is congestion management. When the network is overloaded, QoS mechanisms operate to manage congestion by prioritizing traffic and preventing network collapse.

LTE and 5G networks employ different mechanisms to achieve QoS. These include traffic classification or identifying different types of traffic based on traffic characteristics, such as voice, video and web browsing. Other QoS mechanisms include admission control, or determining if a new user or service can be admitted to the network based on available resources and QoS requirements. Another QoS mechanism is scheduling or prioritizing and scheduling the transmission of data packets to meet QoS targets. Another QoS mechanism is congestion control or implementing mechanisms to prevent network congestion and manage traffic during peak times.

While similar QoS concepts are employed in both LTE and 5G, there are differences in implementation. For example, LTE uses evolved packet system (EPS) bearer profiles to define QoS parameters for different services. This focuses on providing reliable voice and data services. 5G introduces more granular QoS control with QoS flow identifiers (QFIs) and network slicing. 5G supports a wider range of services with diverse QS requirements including ultra-low latency, high reliability and massive machine type communications.

A parameter called QoS Class Identifier (QCI) is an additional element in implementing QoS in LTE and 5G networks. In 5G networks, the concept may be referred to as 5QI for 5G QoS Identifier. QCI acts as a reference for network nodes such as base stations to determine the appropriate level of service for different types of traffic. Different types of traffic, such as voice, video, and data, have distinct QoS requirements. These traffic types are assigned specific QCI values. Each QCI value corresponds to a set of QoS parameters. These include, for example bit rate, or a minimum guaranteed data rate; latency, or a minimum acceptable delay; jitter, or a tolerance for packet arrival time variations; or packet loss, referring to an acceptable packet loss rate.

Network nodes use the QCI value to determine how to allocate network resources such as bandwidth, power, etc., to different traffic flows. Higher priority traffic, with lower QCI values, receives preferential treatment. The QCI is used to prioritize packet forwarding, ensuring that critical traffic is delivered with minimal delay and loss. In the event of network congestion, QCI helps in deciding which traffic to prioritize and which traffic to drop or delay.

QCI values typically range from 1 to 9. 5QI values generally have more options and granularities. QCI and 5QI values are scalar values that indicate the QoS a specific bearer or data flow should receive. QCI and 5QI parameters include scheduling weights, which can be used to set scheduling priority weights. Scheduling weight is a parameter used in 5G and other networks for resource allocation. The scheduling weight is a numerical value assigned to a UE or user data flow to indicate its priority or importance in the scheduling process for communicating packets and other information between a base station and two or more UE. A higher scheduling weight implies a higher priority for resource allocation, meaning the UE or data flow is more likely to be granted access to network resources like bandwidth and transmission time. By assigning appropriate scheduling weights, the network can meet different Quality of Service (QoS) requirements for various applications. For instance, real-time applications like voice calls might have higher weights compared to less critical data transfers.

The 5QI to QoS mapping is provided by a 5G QoS profile, which also includes other parameters like packet delay budget, priority level, and packet error rate. QCI and 5QI values and their corresponding QoS parameters are standardized by 3GPP to ensure interoperability between different network equipment vendors. Network operators can customize the mapping between these QCI values and QoS parameters to meet specific service requirements. For example, voice calls require low latency and low packet data loss, so they are assigned a low QCI or 5QI value such as 1 or 2. Video streaming, on the other hand, requires a higher bit rate but can tolerate some delay and packet loss, so it might be assigned a QCI value of four or five.

In a RAN system such as LTE and 5G, various QoS treatments may be used. QoS treatments refer to how a 5G or other network manages traffic to ensure a smooth user experience for users associated with UE in the network. For example, in a first example treatment, the network pre-configures selected QoS criteria and then applies those criteria to users in the network. In this case, static QoS differentiation is based on QCI or 5QI values with relative priority scheduling defined by different scheduling weights. For example, the network or a network node may statically set the scheduling weight for 5QI values (5, 6, 7, 8) to (64, 32, 8, 2) to differentiate the handing of the 5QI classes.

In a second example treatment, weight settings may be dynamically scheduled. For example, scheduling weight settings may be dynamically changed for a particular user in 5QI or QCI based on a delay associated with the user. The latency experienced by the user may be compared with a particular threshold and, if for example, average latency exceeds the threshold, the user's scheduling weight may be increased. This may occur, for example, if the delay is based on scheduling. In an example, the UE may require low latency for a particular application but current high traffic levels in a serving gNodeB prevent that. The scheduler in the gNodeB network can increase the relative weight of the user or UE and schedule the user first or sooner in time for access to the network.

In a third example treatment referred to as slicing or network slicing, the network may assign or allocate a slice of radio network resources at a network location using radio resources partitioning (RRP). This operates to reserve the designated resources exclusively for a given user or group of users with certain QoS settings. RRP is a component of network slicing in 5G and other networks. RRP enables the exclusive allocation of radio resources to specific users or groups of users. Each of the slices can be associated with a particular characteristic such as throughput, latency, security and priority. Thus, a given slice can be associated with a QoS treatment.

As indicated, the third example treatment is based on the concept of a slice. A slice becomes associated with a group of users or as a certain user group. Group members have some attributes in common. From a pool of resources in the network, a portion or slice of the resources is assigned to one or more groups of users. For example, for a particular resource available in the network or at a node or branch of the network, a slice of 10 percent of the particular resource may be assigned to users in group A and a slice of 20 percent of the particular resource may be assigned to users in group B. Users are subscribers or UE. An index may be assigned and used to associate users with a group.

Any suitable radio resource attribute may be used to group users. Examples of such radio resources include radio frequency selection priority (RFSP), subscriber profile identifier (SPID) and public land mobile network identifier (PLMN ID). RFSP is a parameter used to prioritize the selection of radio access technologies (RATs) and frequencies for a specific user or device in a 5G network. It may assist in optimizing network resource utilization and improving user experience by guiding the network on which RAT or frequency band to use based on various factors like signal strength, congestion, and user preferences. SPID is a unique identifier associated with a subscriber or device profile and containing information about the user's preferences, service entitlements, and QoS requirements. It enables the network to tailor services and resource allocation based on the specific needs of the user. For example, a high-priority user might have a SPID with different parameters compared to a regular user. The PLMN ID is a unique identifier assign to a mobile network operator. It generally includes a mobile country code (MCC) and a mobile network code (MNC).

In this example treatment, users having a particular assigned RFSP or SPID may have access to reserved QoS resources accessible in an assigned slice. The index formed by the RFSP value or the PLMN ID value may be used to group users and designate services or QoS resources for that group of users. Stated alternatively, the index associated with a group and a resource may be used to filter out users from others. For example, all users having an RFSP value of 10 are grouped together into a common group. Thus, a slice of that particular radio resource associated with that RFSP value of 10 become reserved for the members of that group, to ensure or provide a certain QoS level for the members of the group.

In an example of radio resource partitioning, available radio spectrum is divided into smaller units called Physical Resource Blocks or PRBs. The PRBs are then grouped into partitions. Each partition is dedicated to a specific network slice. Each slice is assigned a specific share of radio resources based on, for example, its QoS requirements. This partitioning ensures that different slices operate independently, preventing interference and guaranteeing the required performance for each slice. Each slice can have tailored QoS parameters, ensuring the best performance for its specific applications.

Three examples of QoS treatments have been described here. Other QoS treatments may be selected as well, based on system requirements and availability.

These conventional QoS treatments work well to ensure different types of data traffic receive the appropriate level of service based on their specific requirements. However, one problem with conventional QoS treatments is that those existing QoS treatments are used statically. That is, for a given user or a given UE, a certain selected QoS solution will be used by the network during operation of the device on the network.

However, different QoS solutions have different pros and cons which may make them more or less appropriate for a particular user or application. For example, the normal QoS differentiation solution using relative priority scheduling defined by different scheduling weights offers more spectrum efficiency for the radio access network 202 and provides better for fairness of access to resources among different users. However, this first QoS treatment might not be adequate to meet service requirements in a scenario in which the network is heavily loaded with traffic. Similarly, the QoS treatment in which the slice with RRP may be more reliable to meet service requirements in a heavy congested situations but could cause inefficient use of resources due to reservation of some resources for some users. The conventional QoS solutions are static and in the nature of set-it-and-forget-it for a particular user or application or environment.

Moreover, and in contrast, the usage of the mobile communication network 200 has become very dynamic. This is true for the types of usage of the applications and the traffic patterns of usage. For example, a user with a UE may in one moment make a simple voice call to another party. In a separate moment, the same user and the same device may engage in an intensive gaming application involving Virtual Reality (VR) or Augmented Reality (AR) and requiring much higher data rates and lower latency than a voice call. Similarly, the radio access network 202 enables user mobility, so the usage of portions of the network can change very dramatically over even short amounts of time. In one example, a base station or network segment serving a downtown office building may be heavily loaded during business hours but, after those business hours when workers have gone home, the network usage is much less. Similarly, a network segment that services a facility such as a sports arena or stadium may be relatively quiet during much of the week, but on game day, when many viewers attend and take photos and videos to upload to the network, the network may be near capacity. Thus, for individuals and for portions of the network itself, network usage may be highly dynamic. However, with the conventional static, separate configuration for QoS, the QoS setting for a user or subscriber, or an application, or network cannot be readily reconfigured.

Generally, a user associated with a UE such as UE 204 is a subscriber to services operated by the operator of the mobile network. The subscriber pays, for example, a monthly subscription fee and receives service in return. The features of the subscription are provisioned on the network for the user so that the user can access those aspects of the subscription.

A Service Level Agreement (SLA) for a cellular subscriber is a contract between a mobile network operator (MNO) and its customer that outlines the level of service the customer can expect. Essentially, the SLA is a promise from the MNO to deliver a specific quality of service. If the MNO fails to meet these standards, there are often defined consequences, such as service credits or refunds. Commonly used SLA metrics include coverage area, throughput or data rate, call quality, for example measured by dropped calls or call setup time, etc., network latency and outage duration. A typical SLA will include descriptions of the services covered by the SLA, performance metrics, service levels, penalties and some means for dispute resolution.

In one example, a user or group of users may be guaranteed a throughput of 5 Mbps. Another user may use applications that do not require high throughput but do require low latency. Other users do not have particular requirements and may be termed best efforts users. The SLA for each respective user will define the level of each service or feature to which a user is entitled.

FIG. 2B depicts an illustrative embodiment of a method 230 in accordance with various aspects described herein. The method 230 presents a novel QoS treatment solution. In exemplary embodiments, the method includes dynamic switching among multiple levels of QoS treatment solutions. Switching is based on current fulfillment by the network of the SLA for the subscriber or UE. In the example, four levels or options for QoS treatment are shown in table 232. Each level 1 through 4 corresponds to a QoS solution or configuration used by the network to control QoS settings in a system such as the system 200 of FIG. 2A. The dynamic switching may be driven by how well a relevant service level agreement (SLA) is fulfilled for a user.

The method 230 includes a set of steps that may be repetitively executed to adjust the QoS treatment of a user in a mobile network. A performance level is measure and compared with a service level agreement (SLA) associated with the user or the UE. The user may have a subscription for services to be provided on the mobile communication network. The subscription or other agreement between the user may define a service level to which the user is entitled for one or more UE operated on the network. For example, the user may be an individual user who employs a UE for gaming on the network. The SLA may reflect that usage and may define a throughput level and a latency which are guaranteed to the user. The mobile network operator will take all appropriate steps to provide the promised service level to the user.

Such appropriate steps include adjusting the QoS treatment for the UE by the network. The adjustment is done dynamically to reflect variation in usage or traffic level of the network and variation in usage by the UE or applications running on the UE. The adjustment is done in real time in response to varying conditions in the network and for the UE.

QoS treatment is achieved by modifying a selected QoS treatment solution according to table 232. Table 232 sets out an exemplary set of QoS solutions that may be selected during performance of the method 230. In a first level, Level 1, the QoS solution or configuration corresponds to default scheduling weight settings defined by the standard network parameters QCI or 5QI. As noted above, different types of network traffic, such as voice, video, and data, have distinct QoS requirements and these different traffic types are assigned specific QCI or 5QI values. Each QCI value corresponds to a set of QoS parameters. The first level of table 232 may be set as a default level.

In a second level, Level 2, the QoS solution or configuration corresponds to changing the scheduling weight. As noted above, scheduling weight for a user or UE is a numerical value assigned to the UE or user data flow to indicate its relative priority or importance in the scheduling process for communicating packets and other information between a base station and two or more UE.

A network element such as a gNodeB includes a function called a scheduler which controls timing at which a packet or other information is sent to or received from a UE at the base station. Scheduling allocates radio resources to various devices and entails selecting which device or user will have access to the radio resources at a specific moment. Scheduling is dependent on a number of variables, including an application's priority level, QoS needs, volumes of data to be transferred, and the network's current traffic load.

When the gNodeB is relatively busy, the scheduling is controlled according to the priority scheduling weight. A UE or data flow with a higher scheduling weight is prioritized over those with lower weights. This might be assigned to a user experiencing critical real-time applications (e.g., video conferencing, online gaming) or a user with a strong channel quality. A UE or data flow with a lower scheduling weight has a lower priority. This could be assigned to a user with background data transfer or a user with a poor channel condition. A scheduler may have several or many priority levels or scheduling weights to assign to a UE. Scheduling weights may be adjusted dynamically based on changing network conditions and user requirements. In the example of FIG. 2B, the scheduling weight may be changed by multiple levels.

In a third level, Level 3 in table 232, the QoS solution or configuration corresponds to creating a slice, or using an existing slice, with radio resource partitioning (RRP). In the example, the slice is given a minimum allocation. As noted above, the gNodeB or network may assign or allocate a slice of radio network resources at a network location using RRP. This operates to reserve the designated resources exclusively for a given user or group of users with certain QoS settings. The group of users may be associated or grouped in any suitable way, such as based on RFSP or PLMN ID.

In a fourth level, Level 4 in table 232, the QoS solution or configuration corresponds to increasing the RRP allocation to a next level for a group of users including the user or UE of interest. As indicated, the change in RRP allocation level may be according to multiple levels. For example, specific physical resource blocks (PRBs) may be partitioned among different users or services.

While table 232 shows four levels for variation and selection of a QoS treatment solution, any suitable number of levels may be used, depending on design and implementation requirements. The example of FIG. 2B is intended to be exemplary only. An individual level among a plurality of levels may be selected according to current device needs and network status. For example, selection of an objectively best level enhances the user experience by using the most suitable QoS solution for a given user per SLA.

The method 230 may be used to dynamically set a QoS value for a user or UE such as UE 204, UE 206 or UE 208 in a mobile communications network such as system 200 (FIG. 2A). The method 230 may operate continuously when the user or UE is active on the network. Alternately, the method 230 may operate intermittently when the user is due or attempting to communicate over a radio channel between the UE and a gNodeB or other network infrastructure element. The method 230 may be initiated when the user or UE has data for communication on a downlink or an uplink, or at any other appropriate time. The method may be implemented as a software routine or a module incorporating hardware and software in a gNodeB, for example. As such, the method 230 has access to current and historical network performance and status information, such as KPI information, as well as user information about a UE, an application or other functionality of a UE, etc.

At step 234, the QoS level for the UE is set to a default value corresponding to level 1. As indicated in the table 232, level 1 corresponds to default scheduling weight setting defined by the standard network parameters QCI or 5QI. For example, at step 234, if the UE has video data to convey, the 5QI level may be set at 6, 7, or 8 according to normal network operation.

At step 236, the method 230 includes determining if the SLA for the user is satisfied. As noted, the SLA for the user or device sets out one or more performance characteristics to which the user or UE is entitled and which the network operator is obliged to meet. Thus, step 236 may include retrieving the SLA for the user or for the device, such as based on identification information such as a mobile identification number or electronic serial number associated with the UE or the user. The identification information may, in turn, be used to retrieve subscription information associated with the user, the UE or multiple devices of the user. The subscription information may set out SLA requirements, or other available information may set out the SLA requirements.

In general, accessing the SLA information and performance information is an end-to-end function in the network, involving the radio access network (RAN) 202 and the core network 210. Thus, in one example, the may RAN 202 may obtain the necessary information to evaluate performance in step 236 and step 238. In another example, a service management and orchestration (SMO) function may monitor end-to-end performance including the service perspective and provide input information to the RAN including a gNodeB to evaluate satisfaction of the SLA. The SMO is responsible for managing and orchestrating various network functions and components of the RAN, automating network operations and processes, optimizing network performance and resource utilization, and ensuring network security and reliability. Functions of the SMO may be performed by equipment located in the cloud or in a data center with network connections to the core network 210 and to the RAN 202 including a RAN intelligent controller (RIC).

Further, step 236 may include retrieving historical and current performance data for the user or the UE. Such information may be collected by the mobile communications network and stored, for example, as key performance indicator (KPI) information or in call detail records (CDR) associated with the UE operating on the network. The KPI or CDR information may be processed to determine the extent to which the network is fulfilling network requirements under the SLA for the user or UE. For example, if the SLA specifies that the UE is entitled to 10 Mbps throughput and a latency no more than 50 ms, the retrieved KPI and CDR information may be accessed to compare the actual performance level with the expected SLA level. An expected level may be derived from terms of the SLA. The expected level may be used as a threshold or to develop a threshold for comparison with current KPI or other performance information for the network, the gNodeB or the UE. Any other suitable technique for verifying satisfaction with the terms of the SLA may be used.

At step 238, the method 230 determines if the network performance meets the terms of the SLA, exceeds the terms of the SLA, or falls below the terms of the SLA. If the network performance meets the terms of the SLA, control returns to step 236 and no modifications may be deemed necessary. If all SLA terms are met, operation may remain in a loop including step 246 and step 238 until performance fails to meet the terms of the SLA.

At step 238, if the network performance is deemed to be below the requirements of the SLA, at step 242, the QoS treatment solution selected and applied for the user and the UE is increased to the next level defined by table 232. In one example, the scheduling weight assigned to the UE may be adjusted upward to give the UE a higher priority relative to other UEs in the network or attached to the same gNodeB. Other UEs share the same radio resources in the RAN at the gNodeB. By boosting the scheduling weight of the UE, the UE will receive a higher priority and accordingly more resources. For example, at a congested gNodeB, a packet designated for transmission to a selected UE will be given higher priority based on the increased scheduling weight and will be transmitted to the UE sooner than it would have been transmitted at the lower priority. The effect will be to reduce the latency as measured at the UE, by reducing waiting time at the gNodeB for transmission of the packet over the radio channel.

As noted in FIG. 2B and table 232, the scheduling priority may be adjusted upward by one level or multiple levels. For example, if the network performance compared with the SLA requirements indicates that the network is failing badly relative to expected performance, the scheduling weight may be increased by several levels to move packets at the gNodeB and bound for the UE to a much higher priority and much sooner transmission, to improve network performance relative to the SLA requirements. The extent to which the scheduling weight may be adjusted at step 242 level 2 may be dependent on other factors such as traffic loading at the gNodeB, the presence of higher priority traffic at the gNodeB such as first responder traffic, which may be assigned the highest priority in the network.

After adjusting the QoS by increasing to the next level, control returns to step 236 to further evaluate performance of the network for the UE relative to the SLA. In some embodiments, a time delay may be introduced in order to give the network time to respond to the changed QoS level. This, in effect, introduces hysteresis to the method 230 so the system does not enter a condition of rapidly switching between two or more non-stable states. For example, the method 230 may wait 2 minutes or 5 minutes or a variable amount of time before performing the evaluation of step 236 and step 238 again.

If, at step 238, the network performance is deemed to be above the requirements of the SLA, at step 240, the QoS treatment solution selected and applied for the user and the UE is decreased to the next-lower level defined by table 232. For example, if the method 230 is operating at Level 2 of table 232, the scheduling weight assigned to the UE may be adjusted downward to give the UE a lower priority relative to other UEs in the network or attached to the same gNodeB. Further, the method 230 may select a new level, Level 1, for the UE to better conform to the requirements of the SLA.

For example, if the SLA specifies that the UE is entitled to 10 Mbps throughput and a latency no more than 50 ms, KPI and CDR information may be accessed to compare current actual performance level with the expected SLA level. If, in this example, the throughput is 20 Mbps and latency is 20 ms, far exceeding the SLA requirements, the method 230 may switch to Level 1 and select default scheduling weight settings according to standard QCI or 5QI operation. The UE will thus be assigned a reduced scheduling weight or priority and performance for the UE will degrade to some degree but still within the limits of the SLA.

After adjusting the QoS by decreasing to the next level, control returns to step 236 to further evaluate performance of the network for the UE relative to the SLA. In some embodiments, a time delay may be introduced in order to give the network time to respond to the changed QoS level.

In this manner, the method 230 smoothly and dynamically adapts QoS treatments to performance requirements set by the SLA for the user and comparable SLAs of other users or UEs. Further, in this way, the method 230 adapts to changing performance in the network and by the user. As network loading and traffic levels change, the method 230 adapts QoS to continue to meet the SLA requirements. Similarly, as device usage changes, the method 230 adapts QoS to continue to meet SLA requirements.

The method 230 may remain in a loop as illustrated, comparing current network performance with an expected SLA fulfillment status. When current performance falls below the SLA requirement, the method 230 includes increasing (step 242) the QoS treatment solution to a higher level to improve network QoS performance. As indicated, the QoS treatment solution level may be increased all the way to Level 4 in table 232, if that is permitted. Some QoS solutions may not be permitted or available for some users or some applications. Similarly, when current performance exceeds the SLA requirement, the method 230 includes decreasing (step 240) the QoS treatment solution to a lower level to degrade or reduce the network performance to a level still in line with the SLA. Degrading the network performance may be appropriate to free up radio resources for other users or applications that would otherwise be assigned to the UE under consideration and which yielded (at step 238) a performance that exceeds the network operator's obligations under the SLA.

In a further example, if the method 230 has selected Level 2 for the UE or the application but the test of step 238 indicates that the current performance for the UE falls below the requirements of the SLA, at step 242, the method may select Level 3 of table 232. According to Level 3, a slice of network radio resources may be created or designated for use by the UE. In an example, a percentage of resources, such as 10 percent of the resources of the slice, is assigned to usage by a group of users. In an example, if the UE has been assigned a radio frequency selection priority (RFSP) value, all UE devices assigned with that RFSP value may be grouped together and assigned to a slice of radio resources. This operates to reserve the designated radio resources exclusively for the UE, the user or the group of users with certain QoS settings.

Going further, if operation at Level 3 still fails to meet SLA requirements (step 238), the method 230 may assign the UE to Level 4. Level 4 includes increasing the extent or amount of radio resources assigned to the slice or by assigning the user to additional slices. Each of the slices can be associated with a particular characteristic such as throughput, latency, security and priority. Thus, a given slice can be associated with a QoS treatment. The assignment to a slice thus can be used to adjust, by increasing or decreasing, the UE or user's access to radio resources.

In a mobility network, the environment seen by the network and the environment seen by the UE is constantly changing. Each base station or gNodeB serves a cell covering a geographic area. If the UE is at the cell edge, it is relatively distant from the gNodeB, so signal strengths are relatively weak. Also, at the cell edge, the UE may be subject to radio frequency (RF) interference from adjacent cells. Thus, the radio condition at the cell edge can be quite poor, and the UE at the cell edge may need more radio resources to fulfill the SLA.

However, when the UE moves from the cell edge to a position near the cell center, the UE does not need the same resources. Nearer the cell center, the UE generally experiences much stronger received signal strength and much less interference. Therefore, relative to the UE at the cell edge, the UE at the cell center can receive decreased QoS treatment at a lower level. As the UE moves from the cell edge toward the cell center, the method 230 may gradually lower the selected level for the UE from Level 4 to Level 3 to Level 2 and to Level 1.

Complementary behavior will apply for the UE that moves from the cell center toward the cell edge, or to a cell region with high RF interference, subject to severe signal fading, or a region with many other users who are using radio resources, etc.

In some embodiments, other levels of hierarchy may limit or modify operation of the method 230. As noted, in one example, a service management and orchestration (SMO) function may monitor end-to-end performance in the network. The SMO may provide input information to the RAN including a gNodeB to evaluate satisfaction of the SLA. The SMO has access to network information about KPIs for various network elements as well as information about SLA with various subscribers. The SMO or another network element outside the RAN 202 may perform some functions of the method 230.

Also, in FIG. 2B, method 230 shows dynamic switching for a given user. In some implementations, the system will likely serve multiple users. When it comes to dynamically upgrading to the next level, since the current solution cannot fulfill the SLA, the method 230 may need to check if a system resource is adequate to serve this user considering all the other existing users. This is especially true given that there may be higher priority users requiring the service. For example, first responders and emergency networks generally have the highest priority in the network. A user seeking to raise QoS treatment to the next level may be unable to do so because of the present of higher priority users. In some instances, the system cannot upgrade this user to the next level solution due to higher priority users.

In another example, multiple users may have the same relative priority in the network. In such cases, any suitable strategy for prioritizing one user or group of users over another, any suitable strategy may be used. One example is a first-come, first-served policy in which a user or group seeking a particular scheduling weight or radio resources is given access to those over users that come later. Another example is a round-robin system in which users take turns or access to a particular QoS treatment is assigned to a user or group of users serially for a given time, such as 30 minutes or an hour. After the given time is elapsed, another user or group of users is given access to the particular QoS treatment.

In some embodiments, some or all of the operations of method 230 may be implemented in conjunction with an artificial intelligence or machine learning process (AI/ML). For example, an rApp may be instantiated in the service and management orchestration (SMO) function in the system 200. An rApp is generally a software application designed to run on a Non-Real Time RAN Intelligent Controller (Non-RT RIC) to realize different RAN management and optimization use cases in an automated way. Generally, an rApp includes control loops operating on a time scale of one second or longer. This makes the rApp ideal to implement an AI/ML process to predict and make recommendations on how to dynamically adjust switching among multiple users with different QoS strategies. Any suitable artificial intelligence process or machine learning model may be used to perform these functions.

As noted, a mobility network changes very rapidly due to movement of UEs and changes in activities on the UEs. Features such as a QoS treatment depend on a wide variety of factors including network factors such as traffic and loading as well as individual factors such as applications being used by UE as well as the geographic location of the users. Switching QoS treatments further changes the network operation. However, all this activity creates training data that can be used to train a supervised machine learning model to make predictions about future activity in the network and to make recommendations about a particular QoS treatment for a particular user at a particular time and location. Ongoing operation, with or without AI/ML control, will enable development of particular patterns and those patterns can be used to decide which is the best way to upgrade or not upgrade as user's QoS.

The system and method disclose herein offer several benefits that can significantly improve the user experience and overall performance of the system 200.

First, by adaptively switching the QoS treatment solution per the SLA for a given user and based on contention among multiple users, the system and method in accordance with various features described herein can achieve optimal tradeoff between meeting the SLA for a given user and maximize spectrum efficiency and utilization. Moreover, the claimed system and method enhances the user experience by using the most suitable QoS solution for a given user per SLA. Still further, the system and method help the network operator to optimize the network design and build an optimized network resource utilization pattern.

While for purposes of simplicity of explanation, the respective processes are shown and described as a series of blocks in FIG. 2B, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

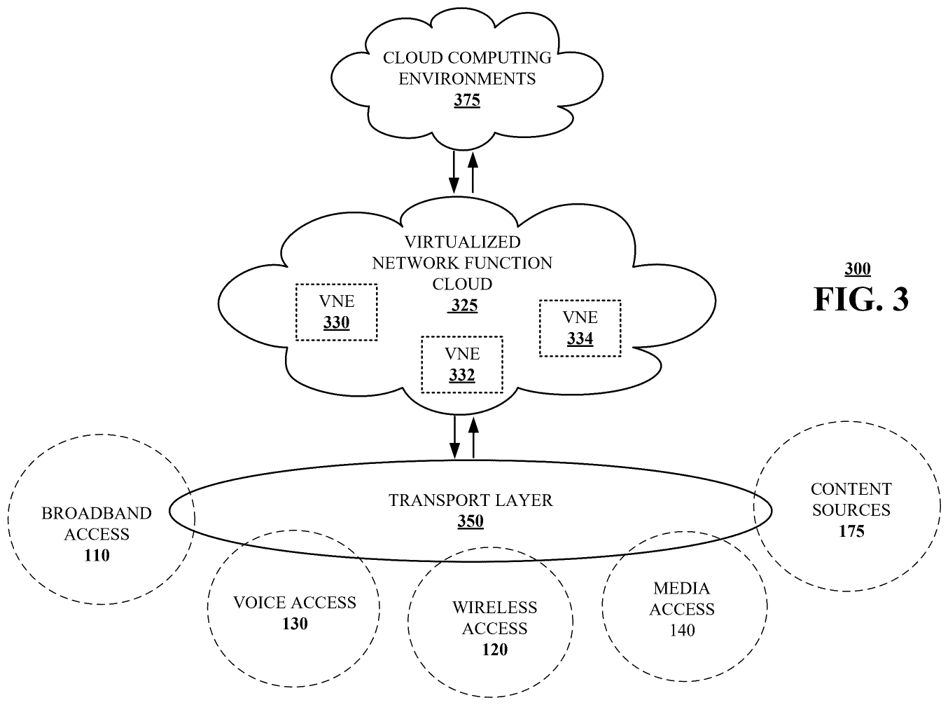

Referring now to FIG. 3, a block diagram is shown illustrating an example, non-limiting embodiment of a virtualized communication network in accordance with various aspects described herein. In particular a virtualized communication network 300 is presented that can be used to implement some or all of the subsystems and functions of system 100, the subsystems and functions of system 200, and method 230 presented in FIG. 1, FIG. 2A, FIG. 2B and FIG. 3. For example, virtualized communication network 300 can facilitate in whole or in part automatically adjusting QoS for a UE in a mobile network to conform to a service level agreement for the UE.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements - which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general-purpose processors or general-purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it is elastic: so, the resources are only consumed when needed. In a similar fashion, other network elements such as other routers, switches, edge caches, and middle boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized and might require special DSP code and analog front ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements do not typically need to forward large amounts of traffic, their workload can be distributed across a number of servers - each of which adds a portion of the capability, and which creates an elastic function with higher availability overall than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud or might simply orchestrate workloads supported entirely in NFV infrastructure from these third-party locations.

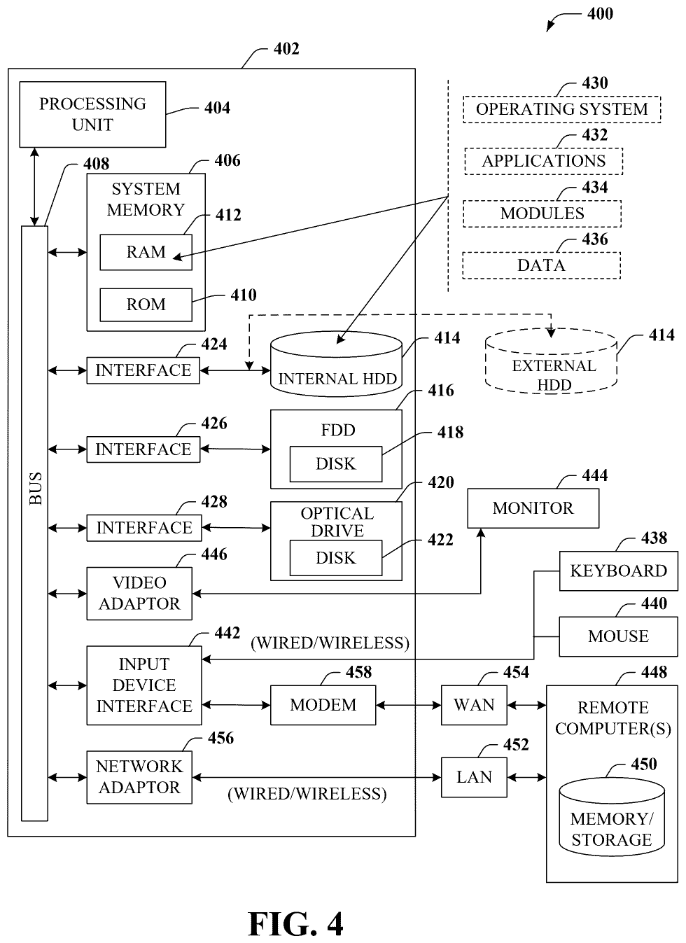

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part automatically adjusting QoS for a UE in a mobile network to conform to a service level agreement for the UE.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM), flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures.

The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high-capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

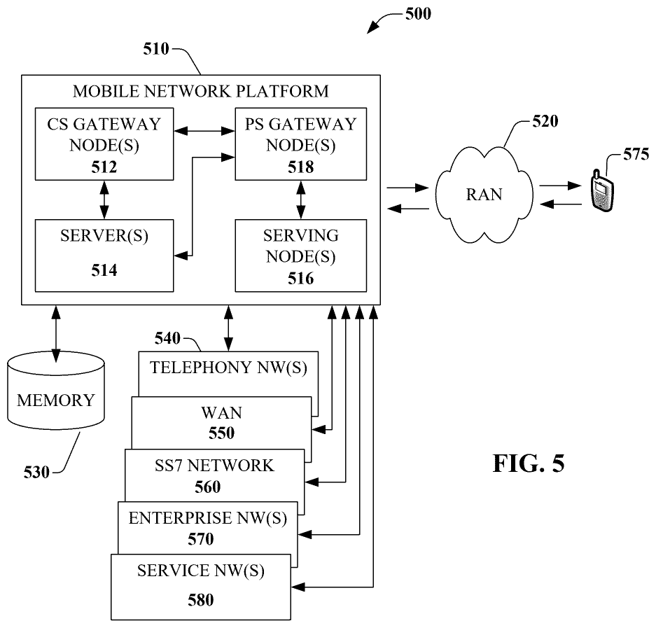

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part automatically adjusting QoS for a UE in a mobile network such as the mobile network 510 to conform to a service level agreement for the UE. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processors can execute code instructions stored in memory 530, for example. It should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

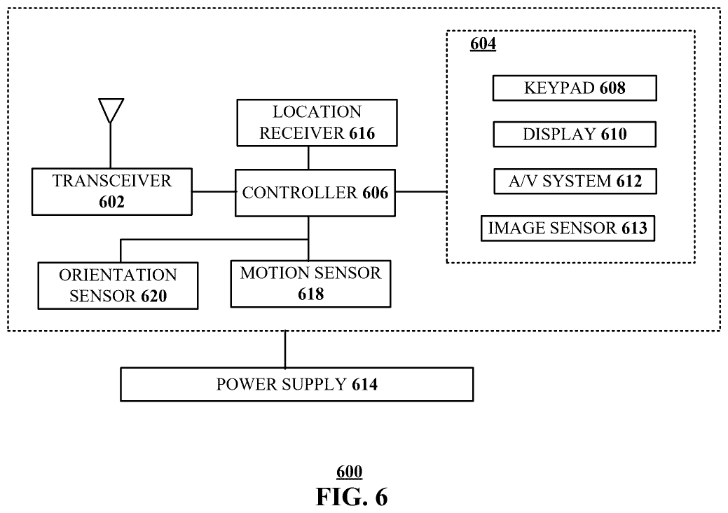

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, communication device 600 can facilitate in whole or in part automatically adjusting QoS for a UE such communication device 600 in a mobile network to conform to a service level agreement for the UE.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, Wi-Fi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high-volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, Wi-Fi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and does not otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically identifying acquired cell sites that provide a maximum value/benefit after addition to an existing communication network) can employ various AI-based schemes for carrying out various embodiments thereof.

Moreover, the classifier can be employed to determine a ranking or priority of each cell site of the acquired network. A classifier is a function that maps an input attribute vector, x=(x₁, x₂, x₃, x₄ . . . xₙ), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria which of the acquired cell sites will benefit a maximum number of subscribers and/or which of the acquired cell sites will add minimum value to the existing communication network coverage, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device, comprising:
a processing system including a processor; and
a memory that stores executable instructions that, when executed by the processing system, facilitate performance of operations, the operations comprising:
selecting a quality of service (QoS) treatment for user equipment (UE) in a mobile communications network;
applying the QoS treatment for the UE;
determining compliance with a service level agreement (SLA) according to the QoS treatment;
adjusting the QoS treatment to an updated QoS treatment based on the determining compliance with the SLA; and
applying the updated QoS treatment to the UE.

2. The device of claim 1, wherein the operations further comprise:
determining performance information for the UE operating in the mobile communication network according to the QoS treatment; and
increasing the QoS treatment to a higher priority QoS treatment in response to the performance information for the UE falling below a performance threshold of the SLA.

3. The device of claim 2, wherein the operations further comprise:
decreasing the QoS treatment to a lower priority QoS treatment in response to the performance information for the UE exceeding the performance threshold for the SLA.

4. The device of claim 2, wherein the selecting a QoS treatment for the UE comprises:
selecting a Quality of Service Class Identifier (QCI) or a 5G Quality of Service Identifier (5QI) as a default initial value for the QoS treatment for the UE.

5. The device of claim 4, wherein the selecting a QCI or a 5QI comprises:
selecting the QCI or the 5QI based on a type of traffic currently at the UE.

6. The device of claim 4, wherein the adjusting the QoS treatment to an updated QoS treatment comprises:
selecting a new scheduling weight for the UE, wherein the new scheduling weight is selected to decrease the QoS treatment to a lower priority QoS treatment in response to the performance information for the UE exceeding the performance threshold for the SLA; and
wherein the new scheduling weight is selected increase the QoS treatment to a higher priority QoS treatment in response to the performance information for the UE falling below a performance threshold of the SLA.

7. The device of claim 1, wherein the adjusting the QoS treatment to the updated QoS treatment comprises:
creating a radio resource partitioning (RRP) slice for a selected radio resource of the mobile communications network; and
assigning the UE to the RRP slice.

8. The device of claim 7, wherein the operations further comprise:
varying an amount of radio resources allocated to the RRP slice to adjust the QoS treatment to the updated QoS treatment.

9. The device of claim 1, wherein the operations further comprise:
obtaining subscription information for the UE; and
determining a SLA for the UE, wherein the determining is based on the subscription information, and wherein the determining comprises one or more minimum performance characteristics guaranteed to the UE by an operator of the mobile communications network.

10. The device of claim 9, wherein the operations further comprise:
identifying one or more current performance characteristics of the UE on a radio access network (RAN) of the mobile communications network;
comparing the one or more current performance characteristics of the UE with the one or more minimum performance characteristics guaranteed to the UE by the operator of the mobile communications network; and
adjusting the QoS treatment based on the comparing.

11. A non-transitory machine-readable medium, comprising executable instructions that, when executed by a processing system including a processor, facilitate performance of operations, the operations comprising:
applying an initial quality of service (QoS) treatment to user equipment (UE) in a mobile communication system, the initial QoS treatment corresponding to a relative priority of the UE for radio resources in the mobile communication system;
operating the UE according to the initial QoS treatment;
retrieving service level agreement (SLA) information for the UE, the SLA information defining one or more minimum performance characteristics guaranteed to the UE by an operator of the mobile communications system;
determining current performance information for the UE in the mobile communications system;
comparing the current performance information for the UE with the one or more minimum performance characteristics guaranteed to the UE by the operator of the mobile communications system;
adjusting the QoS treatment from the initial QoS treatment to an adjusted QoS treatment to adjust the relative priority of the UE for radio resources in the mobile communication system, wherein the adjusting is responsive to the comparing; and
operating the UE on the mobile communication system according to the adjusted QoS treatment.

12. The non-transitory machine-readable medium of claim 11, wherein the adjusting the QoS treatment from the initial QoS treatment to an adjusted QoS treatment comprises:
selecting a new scheduling weight for the UE based on the comparing to increase or decrease the relative priority of the UE for radio resources in the mobile communication system to conform to the SLA.

13. The non-transitory machine-readable medium of claim 11, wherein the adjusting the QoS treatment from the initial QoS treatment to an adjusted QoS treatment comprises:
creating a radio resource partitioning (RRP) slice for a selected radio resource of the mobile communications system; and
assigning the UE to the RRP slice.

14. The non-transitory machine-readable medium of claim 13, wherein the operations further comprise:
selecting a radio resource to partition, forming selected radio resources;
selecting a group of users including the UE; and
assigning a portion of the selected radio resources to the group of users to adjust the QoS treatment for the group of users.

15. The non-transitory machine-readable medium of claim 14, wherein the selecting a group of users comprise:
selecting the group of users according to a selected radio resource attribute, wherein the selected radio resource attribute comprises one or more of a radio frequency selection priority (RFSP), a subscriber profile identifier (SPID) and a public land mobile network identifier (PLMN ID).

16. The non-transitory machine-readable medium of claim 11, wherein the operations further comprise:
providing, to an artificial intelligence/machine learning (AI/ML) process, the SLA information and the current performance information for the UE in the mobile communication system; and
receiving, from the AI/ML process, a recommendation for adjusting the QoS treatment to adjust the relative priority of the UE for radio resources in the mobile communication system to conform to a SLA for the UE.

17. A method, comprising:
selecting, by a processing system including a processor, a first quality of service (QoS) treatment for user equipment (UE) in a radio access network, the first QoS treatment corresponding to a relative priority of the UE for radio resources in the radio access network;
collecting, by the processing system, performance information for the UE operating in the radio access network according to the first QoS treatment;
receiving, by the processing system, service level agreement (SLA) information for the UE, the SLA information defining a minimum performance level for the UE in the radio access network;
comparing, by the processing system, the performance information for the UE with the minimum performance level;
adjusting, by the processing system, UE QoS treatment from the first QoS treatment to a second QoS treatment to adjust the relative priority of the UE for radio resources in the radio access network, wherein the adjusting is responsive to the comparing; and
updating, by the processing system, the UE QoS treatment to the second QoS treatment.

18. The method of claim 17, comprising:
selecting, by the processing system, a Quality of Service Class Identifier (QCI) or a 5G Quality of Service Identifier (5QI) as the first QoS treatment for the UE, wherein the selecting the QCI or the 5QI is based on a type of traffic at the UE in the radio access network.

19. The method of claim 17, comprising:
adjusting, by the processing system, the relative priority of the UE for radio resources in the radio access network to a lower priority, wherein the adjusting comprises selecting a new scheduling weight to decrease the relative priority of the UE in response to the performance information for the UE exceeding the minimum performance level of the SLA; and
adjusting, by the processing system, the relative priority of the UE for radio resources in the radio access network to a higher priority, including selecting a new scheduling weight to increase the relative priority of the UE in response to the performance information for the UE falling below the minimum performance level of the SLA.

20. The method of claim 17, comprising:
selecting, by the processing system, a radio resource partitioning (RRP) slice for a selected radio resource of the radio access network; and
assigning by the processing system, the UE to the RRP slice to adjust the relative priority of the UE for radio resources in the radio access network.
